(19) United States
(12) Patent Application Publication
(10) Pub. No.: US 2005/0142327 A1
(43) Pub. Date: Jun. 30, 2005

(54) Flame-retardant nylon carpet and method for manufacturing the same

(76) Inventors: Koji Tajiri, Osaka (JP); Morio Tsunoda, Hiratsuka-shi (JP)

Correspondence Address: HARNESS, DICKEY & PIERCE, P.L.C., P.O. BOX 8910, RESTON, VA, 20195, US

(21) Appl. No.: 11/020,044

(22) Filed: Dec. 23, 2004

(30) Foreign Application Priority Data
Dec. 26, 2003 (JP) P2003-432423
Mar. 29, 2004 (JP) P2004-096680

(51) Int. Cl. B32B 33/00; D05C 15/04; D05C 17/02

(52) U.S. Cl. 428/97; 428/95; 156/72

(57) ABSTRACT

A flame-retardant carpet that is superior in safety and capable of exhibiting high flame retardance, by using a pile yarn containing a nylon BCF is provided. A flame-retardant nylon carpet includes a pile yarn containing nylon, a backing fabric containing polyester fiber, and latex used for binding the pile yarn to the backing fabric, wherein the pile yarn has a limiting oxygen index of 26 or more, the backing fabric has a limiting oxygen index of 26 or more, and the latex has a limiting oxygen index of 26 or more.

### BACKGROUND OF THE INVENTION

1. Field of the Invention

The present invention relates to a flame-retardant nylon carpet that is fit to be used in a vessel, a vehicle, an aircraft, a movie theater, a theater, a welfare facility, a tall building and so on, where high flame retardance is required, and also relates to a method for manufacturing the same.

2. Description of the Related Art

In conveying means where a space shielded from a surrounding environment is formed and a building structure where a difficulty in evacuation is predicted, such as a vessel, a vehicle, an aircraft, a movie theater, a theater, a welfare facility and a tall building, it is difficult to solve trouble like a fire in the same manner as in an ordinary house. In particular, The aircraft cannot receive support from the ground in case of happening a trouble such as a fire while flying. Therefore, a member and a structure that are capable of inhibiting the spread of the trouble as much as possible are used. Accordingly, a carpet used as an interior furnishing member for a vessel, a vehicle, an aircraft, a movie theater, a theater, a welfare facility, a tall building and so on also needs to be highly safe, in concrete, highly flame-retardant.

Since before, in a use that requires high flame retardance, a pile yarn obtained by Zirpro flameproofing treatment of making wool yarn react with a titanium compound or a zirconium compound to make the wool yarn flame-retardant has been used. On the other hand, a nylon BCF (bulked continuous filament made of a nylon resin) is superior in elasticity recovering property and superior in abrasion resistance, and therefore, is widely used as a material for a carpet. However the nylon BCF is not used in a use that requires high flame retardance because it is difficult to make it flame-retardant.

Further, in making a material for a carpet flame-retardant, until now, a halogen compound has been used as a flame retardant, and antimony trioxide has been used as a flame retardant aid. However, the flame retardant and the flame retardant aid are not favorable substances from the viewpoint of the safety of the human body and an influence on the environment. In particular, since a passenger cabin of an aircraft is to be a pressurized space while flying, strict safety is required. Therefore, there is a problem that it is impossible to use the frame retardant and the flame retardant aid mentioned above in the aircraft.

A related art that handles the problems described above is a blend of a polyamide resin, which is a material for a carpet, and a triazine flame retardant (refer to Japanese Unexamined Patent Publications JP-A 2002-173829 and JP-A 2002-309433). In the related art, a polyamide multifilament made by the use of a plurality of polyamide monofilaments made of a polyamide resin composition obtained by blending 98 to 80 parts by weight of a polyamide resin and 2 to 20 parts by weight of a triazine retardant is used as a material for a carpet, whereby the carpet is made to be flame-retardant.

However, the related art disclosed in JP-A 2002-173829 and JP-A 2002-309433 has problems as described below. In the case of adding the triazine flame retardant to the nylon BCF that is superior in elasticity recovering property and abrasion resistance, and increasing the amount of addition in order to stabilize the flame retardance thereof, trouble in a filature operation occurs. For example, in the case where 15 parts by weight or more of the triazine flame retardant is added to 98 to 80 parts by weight of the polyamide resin, the flame retardant is dissolved and deteriorated by heat generated at the time of spinning, and a gel-type extraneous matter is generated, which attaches to single yarn as a knot-like extraneous matter at the time of manufacturing the BCF and causes drip breakage, with the result that an operating property is significantly worsened. In particular, in the case of adding 20 parts by weight, which is the upper limit, it is possible to use as resin-plastic, but it is impossible to stably produce yarn for the BCF that is an aggregate of thin single yarns in which single yarn is 30 decitex or less.

Further, a prior art of making polyester fiber, which is a material used for a backing fabric, to be flame-retardant is kneading a flame retardant into the fiber in advance. It is, for example, flame-retardant polyester “TREVIRA CS” produced by Teijin Limited and flame-retardant polyester “HEIM” produced by Toyobo Co., Ltd., and by weaving special yarn for warp yarn and weft yarn by the use of the flame-retardant polyester, it is possible to realize a flame-retardant backing fabric. However, there is a problem such that the flame-retardant polyester fiber is extremely expensive, and therefore, the price of a carpet is increased.

Further, in a related art of making latex flame-retardant, a bromine compound (ethylenebispentabromodiphenyl, decabromodiphenyl ether and so on) and antimony trioxide are mixed and used. However, considering a demand for increase of safety and reduction of a burden on the environment, there is a problem such that use of the halogen compound and the antimony compound as described above is unfavorable.

### SUMMARY OF THE INVENTION

An object of the invention is to provide a flame-retardant nylon carpet that is made by the use of a pile yarn containing a nylon BCF without containing a halogen compound and an antimony compound, superior in safety, capable of exhibiting high flame retardance, and fit to be used in a vessel, a vehicle, an aircraft, a movie theater, a theater, a welfare facility, a tall building and so on, and also provide a method for manufacturing the same.

The invention provides a flame-retardant nylon carpet comprising:
a pile yarn containing nylon;
a backing fabric containing polyester fiber; and
latex used for binding the pile yarn to the backing fabric,
the pile yarn having a limiting oxygen index of 26 or more,
the backing fabric having a limiting oxygen index of 26 or more, and
the latex having a limiting oxygen index of 26 or more.

Further, in the invention, the backing fabric having the limiting oxygen index of 26 or more is formed by coating or impregnating the backing fabric containing polyester fiber with the latex having the limiting oxygen index of 26 or more, and curing the latex.

Still further, in the invention, the pile yarn contains 15 to 25 parts by weight of a triazine flame retardant with respect to 75 to 85 parts by weight of an aliphatic polyamide resin.

Still further, in the invention, the triazine flame retardant is melamine cyanurate.

Still further, in the invention, the pile yarn further contains a heat stabilizer.

Still further, in the invention, the heat stabilizer is one or two selected from hindered phenolic compounds and hindered amine compounds.

Still further, in the invention, the pile yarn further contains a flow stability improver.

Still further, in the invention, the flow stability improver is one or two or more selected from the group consisting of magnesium stearate, montanic acid magnesium, magnesium behenate, magnesium 12-hydroxystearate, calcium stearate, amide ethylene-bis-stearate and amide ethylene-bis-behenate.

Still further, in the invention, the latex contains 30 to 200 parts by weight of expanded graphite with respect to 100 parts by weight of a latex component.

Still further, in the invention, the latex contains 10 to 100 parts by weight of a phosphoric flame retardant with respect to 100 parts by weight of a latex component.

Still further, in the invention, the latex contains 30 to 200 parts by weight of expanded graphite and 10 to 100 parts by weight of a phosphoric flame retardant with respect to 100 parts by weight of a latex component.

Still further, in the invention, the phosphoric flame retardant is red phosphorus.

Still further, in the invention, the phosphoric flame retardant is condensed phosphate.

Still further, in the invention, the condensed phosphate is one or two selected from ammonium polyphosphate and melamine polyphosphate.

Still further, in the invention, the phosphoric flame retardant is a phosphoric ester compound.

Still further, in the invention, the phosphate ester compound is one or two or more selected from the group consisting of 1,3-phenylene bisdiphenyl phosphate, 1,3-phenylene bisdixylenyl phosphate, xylenyl phenyl phosphate and resorcinol bisdiphenyl phosphate.

Still further, the invention provides a method for manufacturing a flame-retardant nylon carpet comprising a pile yarn containing nylon, a backing fabric containing polyester fiber, and latex used for binding the pile yarn to the backing fabric, the method comprising:
a tufting step of implanting piles of the nylon pile yarn having a limiting oxygen index of 26 or more in the backing fabric containing polyester fiber;
a binding step of coating or impregnating the backing fabric containing polyester fiber with the latex containing 30 to 200 parts by weight of expanded graphite and/or 10 to 100 weight parts by weight of a phosphoric flame retardant with respect to 100 parts by weight of a latex component; and
a curing step of curing the latex with which the backing fabric containing polyester fiber is coated or impregnated.

According to the invention, in the flame-retardant nylon carpet, the pile yarn containing nylon has the limiting oxygen index of 26 or more, the backing fabric containing polyester fiber has the limiting oxygen index of 26 or more, and the latex for binding the pile yarn to the backing fabric has the limiting oxygen index of 26 or more. Since each of the materials composing the carpet has high flame retardance such that the limiting oxygen index is 26 or more as described above, the flame-retardant nylon carpet fit to be used in a vessel, a vehicle, an aircraft, a movie theater, a theater, a welfare facility, a tall building and so on and having high flame retardance is realized regardless of using a nylon BCF for the pile yarn.

Moreover, since nylon that is superior in elasticity recovering property and abrasion resistance is used for the pile yarn, even when binding of the pile yarn to the backing fabric is less in comparison with a case where wool pile yarn is used, the carpet is capable of exhibiting equal bulkiness, a covering property and durability, so that it is possible to limit the binding of the pile yarn to the backing fabric to approximately half or less. Furthermore, since it is possible, by setting the limiting oxygen index of the latex to 26 or more, for example, to make the amount of coating used for the binding as small as 500 gr/m² in terms of solid content, weight reduction of the carpet is achieved along with limitation of the binding of the pile yarn to the backing fabric, so that a flame-retardant nylon carpet that is fitter to be used in a vessel, a vehicle, an aircraft, a movie theater, a theater, a welfare facility, a tall building and so on is realized.

Further, according to the invention, the backing fabric having the limiting-oxygen index of 26 or more is formed by coating or impregnating the backing fabric containing polyester fiber with the latex having the limiting oxygen index of 26 or more, and curing the latex. Therefore, it is possible to achieve flameproofing of the backing fabric at a low price without using an expensive material such that polyester fiber itself is made to be flame-retardant.

Still further, according to the invention, the pile yarn contains 15 to 25 parts by weight of a triazine flame retardant with respect to 75 to 85 parts by weight of an aliphatic polyamide resin, and it is preferred that the triazine flame retardant is melamine cyanurate. Moreover, it is preferred that the pile yarn further contains a heat stabilizer and/or a flow stability improver, the heat stabilizer is hindered phenolic compounds and/or hindered amine compounds, and the flow stability improver is one or two or more selected from the group consisting of magnesium stearate, montanic acid magnesium, magnesium behenate, magnesium 12-hydroxystearate, calcium stearate, amide ethylene-bis-stearate and amide ethylene-bis-behenate.

Since flameproofing of the pile yarn is achieved by blending the triazine flame retardant with the aliphatic polyamide resin at a specific ratio, and it is possible, by further adding the heat stabilizer and/or the flow stability improver, to stably produce yarn without causing breakage trouble at the time of spinning, it becomes possible to make flameproofing of the yarn to be compatible with a stable spinning operation.

Still further, according to the invention, the latex contains 30 to 200 parts by weight of expanded graphite and/or 10 to 100 parts by weight of a phosphoric flame retardant with respect to 100 parts by weight of a latex component. Moreover, the phosphoric flame retardant is at least one or more of red phosphorus, condensed phosphate and a phosphate ester compound, examples of the condensed phosphate are ammonium polyphosphate and melamine polyphosphate, and examples of the phosphate ester compound are 1,3-phenylene bisdiphenyl phosphate, 1,3-phenylene bisdixylenyl phosphate, xylenyl phenyl phosphate and resorcinol bisdiphenyl phosphate. The latex thus structured is excellent in safety because a burden thereof on the environment is small, and is capable of achieving stable flame retardance.

Still further, according to the invention, the method for manufacturing a flame-retardant nylon carpet that is low-price, superior in safety and capable of exhibiting high flame retardance is realized.

### BRIEF DESCRIPTION OF THE DRAWINGS

Other and further objects, features, and advantages of the invention will be more explicit from the following detailed description taken with reference to the drawings wherein:

FIG. 1 is a simplified cross section view showing a structure of a flame-retardant nylon carpet according to an embodiment of the invention; and

FIG. 2 is a flowchart showing manufacturing steps of the flame-retardant nylon carpet of the invention.

### DETAILED DESCRIPTION

Now referring to the drawings, preferred embodiments of the invention are described below.

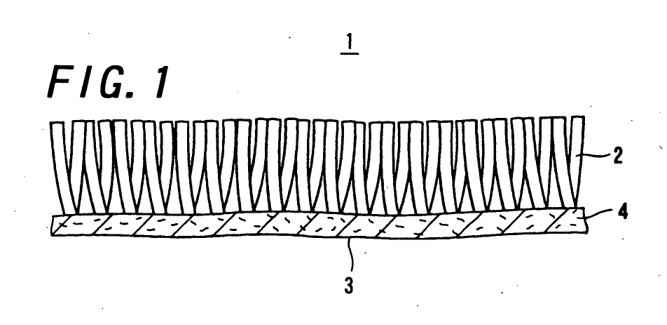

FIG. 1 is a simplified cross section view showing a structure of a flame-retardant nylon carpet 1 according to an embodiment of the invention. A flame-retardant nylon carpet 1 includes a pile yarn 2 containing nylon, a backing fabric 3 containing polyester fiber and latex 4 used for binding the pile yarn 2 to the backing fabric 3. The flame-retardant nylon carpet 1 is used for interior furnishing of a vessel, a vehicle, an aircraft, a movie theater, a theater, a welfare facility, a tall building and so on. In the embodiment, the latex 4 is applied to and permeates the backing fabric 3, and is represented by hatching in the cross section of the backing fabric 3 in FIG. 1.

In the flame-retardant nylon carpet 1 of the invention, the pile yarn containing nylon has a limiting oxygen index of 26 or more, the backing fabric containing polyester fiber has a limiting oxygen index of 26 or more, and the latex has a limiting oxygen index of 26 or more. In terms of flame retardance, an upper limit of the limiting oxygen index is not restricted in specific, but is set to around 38 as a value that can be achieved substantially. In the present specification, the limiting oxygen index (abbreviated as LOI on occasion) is one defined by Japanese Industrial Standards (JIS) K7201, and suggests the density (% by volume) of oxygen that is necessary for the concerned substance to continue combustion.

The pile yarn 2 having the limiting oxygen index of 26 or more is realized by using flame-retardant nylon obtained by making a nylon BCF flame-retardant. The pile yarn 2 may be structured so as to be formed by only flame-retardant nylon, or may be structured by blended spinning of flame-retardant nylon and ordinary nylon, or may be structured by yarn twisting of flame-retardant nylon fiber and ordinary nylon fiber. Besides, the pile yarn 2 may be structured by weaving flame-retardant nylon yarn and ordinary nylon yarn in combination at the time of tufting. By any one of the methods, flame-retardant nylon should be contained at a ratio that enables achievement of the limiting oxygen index of 26 or more.

The flame-retardant nylon is realized by blending 15 to 25 parts by weight, preferably 20 to 25 parts by weight of a triazine flame retardant with 75 to 85 parts by weight of an aliphatic polyamide resin. The triazine flame retardant is melamine, an equimolar reaction product of cyanuric acid and melamine, or the like, and in particular, melamine cyanurate, which is an equimolar reaction product of cyanuric acid and melamine, is preferably used. It is preferred that the blended triazine flame retardant has a mean particle diameter of 5 μm or less.

The reason for restricting a blending range of the triazine flame retardant will be described below. In a case where the blending amount of the triazine flame retardant is less than 15 parts by weight, the limiting oxygen index of 26 or more cannot be achieved, and flame retardance comes short. In a case where the blending amount is more than 25 parts by weight, a thread forming property at the time of spinning greatly lowers, so that a stable operation becomes difficult. Moreover, in a case where the mean particle diameter of the triazine flame retardant is more than 5 μm, there is a risk that single yarn breakage occurs at the time of producing a flame-retardant nylon BCF, so that it is preferred that the mean particle diameter is 5 μm or less.

Furthermore, it is preferred that a heat stabilizer and/or a flow stability improver (a dispersiveness improver) are added to the flame-retardant nylon. Although flameproofing of nylon is achieved by blending a proper amount of triazine flame retardant, stable production of the flame retardant-nylon BCF may be affected depending on the blending amount thereof. However, by adding the heat stabilizer or the flow stability improver, in particular, by adding the heat stabilizer and the flow stability improver, it becomes possible to stably produce the flame-retardant nylon BCF regardless of the blending amount of the triazine flame retardant.

As the heat stabilizer, hindered phenolic compounds and/or hindered amine compounds are preferably used. Examples of the hindered phenolic compounds are, for example, N,N-hexamethylenebis(3,5-di-t-butyl-4-hydroxyphenyl) propionate, such as IRGANOX-1098 produced by Ciba Specialty Chemicals Inc., and examples of the hindered amine compounds are, for example, 1,3-benzene dicarboxyamide and N,N′-bis(2,2,6,6-tetramethyl-4-piperidinyl), such as S-EED produced by Clariant Japan K.K., and it is possible to use them singly or in combination. It is preferred that the heat stabilizer is added so as to become 0.1 to 1.0% by weight with respect to the total weight of the flame-retardant nylon.

Examples of the flow stability improver are a fatty acid metallic salt such as magnesium stearate, montanic acid magnesium, magnesium behenate, magnesium 12-hydroxystearate and calcium stearate, amide ethylene-bis-stearate, amide ethylene-bis-behenate or the like, and it is possible to use them singly or in combination of two or more. It is preferred that the flow stability improver is added so as to become 0.1 to 1.0% by weight with respect to the total weight of the flame-retardant nylon.

The latex 4 having the limiting oxygen index of 26 or more is realized by blending 30 to 200 parts by weight of expanded graphite and/or 10 to 100 parts by weight of a phosphoric flame retardant with 100 parts by weight of a latex component.

Examples of the phosphoric flame retardant are red phosphorus, condensed phosphate, and a phosphate ester compound. Moreover, as the condensed phosphate, ammonium polyphosphate and melamine polyphosphate are preferably used. As the phosphate ester compound, one or two or more selected from the group consisting of 1,3-phenylene bisdiphenyl phosphate, 1,3-phenylene bisdixylenyl phosphate, xylenyl phenyl phosphate and resorcinol bisdiphenyl phosphate are preferably used.

When expanded graphite is used as a flame retardant in addition to the phosphoric flame retardant, the latex 4 exhibits an exceedingly stable flame retardance effect because the flame retardance thereof is further increased. As expanded graphite, a hexagonal-plate-shaped flat crystal of a hexagonal system that has a scaly shape and a relatively large mean particle diameter of approximately 100 to 500 μm, and that has a nature of rapidly expanding approximately 100 to 300 times in a crystal C axis direction when rapidly heated from ordinary temperature to 800° C. or 1000° C. is preferably used.

Examples of a preferable composition of the latex 4 are shown in Tables 1 and 2. By the compositions shown as examples in Tables 1 and 2, the latex 4 having the limiting oxygen index of 30 to 38 can be realized.

The latex 4 shown in Table 1 was prepared so that the viscosity became approximately 9,000 cps (measured by a B-type NO4 rotor) by mixing 5 parts by weight of a thickener (CMC type), and the latex 4 shown in Table 2 was prepared so that the viscosity became approximately 10,000 cps (measured by the B-type NO₄ rotor) by mixing 3 parts by weight of the thickener (CMC type). The viscosity of the latex can be measured by the use of, for example, a B-type viscometer of B-8L model produced by Tokyo Keiki.

TABLE 1

| | |
|---|---|
| SBR latex emulsion: | 100 parts by weight |
| Expanded graphite: | 150 parts by weight |
| Phosphoric flame retardant | 50 parts by weight |
| (ammonium polyphosphate): | |
| Thickener (CMC type): | 5 parts by weight |

TABLE 2

| | |
|---|---|
| NBR latex emulsion: | 100 parts by weight |
| Expanded graphite: | 60 parts by weight |
| Phosphoric flame retardant | 30 parts by weight |
| (red phosphorus): | |
| Thickener (CMC type): | 3 parts by weight |

By coating or impregnating the backing fabric 3 with the latex 4 so that the latex 4 shown in Table 1 becomes 900 gr/m 2 as water emulsion and 400 gr/m² in terms of solid content, or so that the latex 4 shown in Table 2 becomes 1000 gr m² in the total amount of emulsion and 500 gr/m² in terms of solid content, it is possible to bind the pile yarn 2 to the backing fabric 3.

The coating amount of the flame-retardant latex having the limiting oxygen index of 26 or more is held down to a considerably small amount as compared with the coating amount of latex made to be flame-retardant insufficiently that is used for binding in general. Therefore, by combination of the aforementioned flame-retardant nylon having the limiting oxygen index of 26 or more and the flame-retardant latex described above, weight reduction of a carpet is realized, so that the carpet is preferably used in particular for a use of interior furnishing of conveying means that directs to weight reduction in order to reduce fuel consumption, such as a vessel and a vehicle like a train and an automobile. In particular, in the case of an aircraft application, the combination of the flame-retardant nylon having the limiting oxygen index of 26 or more and the latex is realized to pass the flame-retardant regulation for an aircraft and the lightness in weight of carpet is also realized.

The backing fabric 3 having the limiting oxygen index of 26 or more is realized by coating and/or impregnating the backing fabric 3 containing polyester fiber with the latex 4 having the limiting oxygen index of 26 or more, and then curing the latex. In the embodiment, heat treatment at 105 to 160° C. is executed as curing.

Although a polyester nonwoven fabric may be used as the backing fabric 3 for the flame-retardant nylon carpet 1, it is preferred that, in order to make lightness in weight to be compatible with strength enough to bear heavy walking, a polyester woven backing fabric is used. As the polyester woven backing fabric, a woven backing fabric, for example, as disclosed in Japanese Unexamined Patent Publication JP-A 2002-69829 is preferably used. For example, by applying the flame-retardant latex of the composition shown in Table 1 to the polyester woven backing fabric (without pile yarn), the limiting oxygen index is increased from 21 before application to 31 after application.

Thus, by making three composition factors of the nylon pile yarn, the polyester backing fabric and the latex composing a carpet to be flame-retardant so that all of the three have oxygen indices of 26 or more, it is possible to realize a flame-retardant nylon carpet that is preferable for a use in a vessel, a vehicle, an aircraft, a movie theater, a theater, a welfare facility, a tall building and so on.

Examples of the invention will be described below. However, the invention is not restricted to the examples described here.

### EXAMPLES 1 TO 3

Nylon 6 resin 1015 (viscosity measured in conformity with ISO 307 is 150) produced by Mitsubishi Engineering-plastics Corporation was prepared as nylon for the pile yarn, and melamine cyanurate was prepared as the triazine flame retardant.

The blending ratio of the nylon 6 resin 1015 to the melamine cyanurate was set to 85 parts by weight to 15 parts by weight in the example 1, 80 parts by weight to 20 parts by weight in the example 2, and 75 parts by weight to 25 parts by weight in the example 3. Each of them was melted and kneaded at a resin temperature of 240° C. and then pelletized by a biaxial extruder TEX 30 produced by Japan Steel Works, Ltd., whereby a flame-retardant nylon 6 resin composite was produced.

After the obtained pellet was dried for eight hours at 110° C. by a decompression drier, IRGANOX-1098 produced by Ciba Specialty Chemicals Inc. was blended therewith as the heat stabilizer so as to become 0.5% by weight with respect to the total weight of the composite, and amide ethylene-bis-stearate was blended therewith as the flow stability improver so as to become 0.3% by weight with respect to the total weight of the composite.

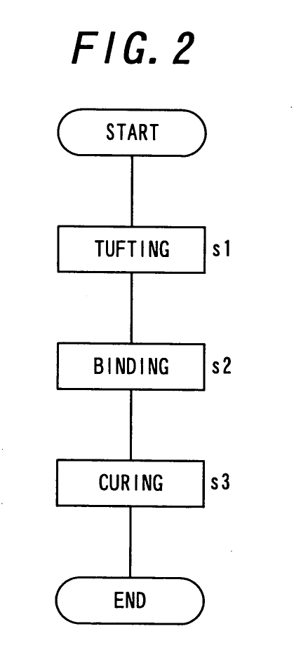

After that, the composite was put into a nylon BCF producing apparatus and melt-spun at 250° C., whereby a solution-dyed BCF of 1440 dtex/56 filament that had a crimp percentage TC of 16% and a trilobar cross section was produced. The flame-retardant nylon BCF was tufted as a pile yarn of 3 ply and 4320 dtex by a 1/8G tufting machine on the backing fabric so that pile weight became 500 gr m², whereby a carpet was obtained in step s1 of FIG. 2.

As the polyester backing fabric, the polyester woven backing fabric disclosed in JP-A 2002-69828 was used. Polyester yarn of 825 dtex/192 fil was used as warp, polyester yarn of 1100 dtex/250 fil was used as weft, low-melting-point ester fiber of 275 dtex/167 fil was used, and an adhesion woven backing fabric having warp density of 26/inch and weft density of 25/inch was used.

By adjusting the addition amount of a thickener (CMC type) to composition shown in Table 3, the flame-retardant latex was prepared so that viscosity measured by a B-type NO₄ rotor (a B-type viscometer of B-8L model produced by Tokyo Keiki) became 10,000 cps.

TABLE 3

| | |
|---|---|
| SBR latex emulsion: | 100 parts by weight |
| Expanded graphite: | 150 parts by weight |
| Ammonium polyphosphate: | 50 parts by weight |

The flame-retardant latex was applied as emulsion for binding of the carpet (a backing agent) so as to become 1000 gr m² and 500 g m² in terms of solid content from the rear surface of the polyester backing fabric in step s2 of FIG. 2, dried at 120° C. by a drier, and firmly attached in step s3 of FIG. 2.

The limiting oxygen index (LOI) of the flame-retardant latex was 35, and the limiting oxygen index of the polyester backing fabric with the flame-retardant latex applied was 31.

### COMPARATIVE EXAMPLE 1

A carpet was produced in the same manner as in the examples 1 to 3 except that 100 parts by weight of the nylon 6 resin 1015 was used and no triazine flame retardant was blended.

### COMPARATIVE EXAMPLE 2

A carpet was produced in the same manner as in the examples 1 to 3 except that the blending ratio of the nylon 6 resin 1015 to the melamine cyanurate was set to 88 parts by weight to 12 parts by weight.

### COMPARATIVE EXAMPLE 3

A composite was made in the same manner as in the examples 1 to 3 except that the blending ratio of the nylon 6 resin 1015 to the melamine cyanurate was set to 70 parts by weight to 30 parts by weight, and put into a nylon BCF producing apparatus, and melt-spinning at 250° C. was tried, but single yarn breakage occurred frequently, and consequently, a nylon BCF could not be obtained. Therefore, a carpet could not be manufactured in the comparative example 3, so that a performance assessment test was not carried out thereon.

The performances of the carpets of the examples 1 to 3 and the comparative examples 1 and 2 were assessed as described below.

(Assessment of Flame Retardance)

Regarding the respective carpets of test materials, a flame retardance test in conformity with a vertical firing test of the airworthiness examination guidelines section III 4-10-2-2 and appendix I-1, 2, 3, 4 of the Civil Aviation Bureau, the Ministry of Land, Infrastructure and Transport, at a flame temperature of 892° C., which is the strictest regulation as a flame retardance assessment test, was carried out. In this test, in a case where a combustion length (=a carbonization length) was less than 20 cm and a combustion time (=a flame remaining time) was less than 15 seconds, and further dropping of test materials did not continue to burn more than the mean five seconds after dropping, namely, the flame retardance assessment test was passed, that is, flame retardance was assessed as good.

(Operation Stability)

Operation stability was assessed depending on whether single yarn breakage occurred or not when the spinning material was put into a nylon BCF producing apparatus and melt-spun. In a case where single yarn breakage did not occur and it was possible to continuously operate with stability, operation stability was assessed as good, and in a case where single yarn breakage occurred and it was impossible to continuously operate, operation stability was assessed as bad.

The results of the performance assessment test are shown together in Table 4. Regarding the carpets of the examples 1 to 3, the flame retardance was good because the carbonization lengths were 3.0 to 4.0 cm and the flame remaining times were all 0.0 second, and the operation stability was also good. However, regarding the carpets of the comparative examples 1 and 2 deviating from the scope of the invention, the flame retardance was bad, and regarding the comparative example 3, the operation stability at the time of spinning was bad.

Further, regarding the carpets of the examples 1 to 3, the assessment result of the flame-retardant test for an aircraft was passed, and the operation stability was also good. However, regarding the carpets of the comparative examples 1 and 2 deviating from the scope of the invention, the assessment result of the flame-retardant test for an aircraft was not passed, and the comparative example 3, the operation stability at the time of weaving was bad.

TABLE 4

| | | | | Comparative | Comparative | Comparative |
|---|---|---|---|---|---|---|
| | Example 1 | Example 2 | Example 3 | example 1 | example 2 | example 3 |
| Nylon 6 | 85 | 80 | 75 | 100 | 88 | 70 |
| (Parts by | | | | | | |
| weight) | | | | | | |
| Triazine flame | 15 | 20 | 25 | 0 | 12 | 30 |
| retardant | | | | | | |
| (Parts by | | | | | | |
| weight) | | | | | | |
| LOI of BCF | 26 | 29 | 30 | 21 | 24 | Single yarn |
| Operation | Good | Good | Good | Good | Good | breakage |
| stability | | | | | | occurred |
| Aircraft flame | 4.0 | 3.2 | 3.0 | Be burned | 9.0 | frequently |
| retardance | | | | down | | and BCF |
| carbonization | | | | | | could not be |
| lenght (cm) | | | | | | obtained |
| Aircraft flame | 0.0 | 0.0 | 0.0 | 40 seconds | 12 to 32 | |
| retardance | | | | or more | seconds | |
| flame remaining | | | | | | |
| time (second) | | | | | | |
| Assesment of | Passed | Passed | Passed | Not passed | Not passed | |
| flame retardant | | | | | | |
| test for | | | | | | |
| aircraft | | | | | | |

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

1. A flame-retardant nylon carpet comprising:
a pile yarn containing nylon;
a backing fabric containing polyester fiber; and
latex used for binding the pile yarn to the backing fabric,
the pile yarn having a limiting oxygen index of 26 or more,
the backing fabric having a limiting oxygen index of 26 or more, and
the latex having a limiting oxygen index of 26 or more.

2. The flame-retardant nylon carpet of claim 1, wherein the backing fabric having the limiting oxygen index of 26 or more is formed by coating or impregnating the backing fabric containing polyester fiber with the latex having the limiting oxygen index of 26 or more, and curing the latex.

3. The flame-retardant nylon carpet of claim 1, wherein the pile yarn contains 15 to 25 parts by weight of a triazine flame retardant with respect to 75 to 85 parts by weight of an aliphatic polyamide resin.

4. The flame-retardant nylon carpet of claim 3, wherein the triazine flame retardant is melamine cyanurate.

5. The flame-retardant nylon carpet of claim 3, wherein the pile yarn further contains a heat stabilizer.

6. The flame-retardant nylon carpet of claim 5, wherein the heat stabilizer is one or two selected from hindered phenolic compounds and hindered amine compounds.

7. The flame-retardant nylon carpet of claim 5, wherein the pile yarn further contains a flow stability improver.

8. The flame-retardant nylon carpet of claim 7, wherein the flow stability improver is one or two or more selected from the group consisting of magnesium stearate, montanic acid magnesium, magnesium behenate, magnesium 12-hydroxystearate, calcium stearate, amide ethylene-bis-stearate and amide ethylene-bis-behenate.

9. The flame-retardant nylon carpet of claim 1, wherein the latex contains 30 to 200 parts by weight of expanded graphite with respect to 100 parts by weight of a latex component.

10. The flame-retardant nylon carpet of claim 1, wherein the latex contains 10 to 100 parts by weight of a phosphoric flame retardant with respect to 100 parts by weight of a latex component.

11. The flame-retardant nylon carpet of claim 1, wherein the latex contains 30 to 200 parts by weight of expanded graphite and 10 to 100 parts by weight of a phosphoric flame retardant with respect to 100 parts by weight of a latex component.

12. The flame-retardant nylon carpet of claim 10, wherein the phosphoric flame retardant is red phosphorus.

13. The flame-retardant nylon carpet of claim 11, wherein the phosphoric flame retardant is red phosphorus.

14. The flame-retardant nylon carpet of claim 10, wherein the phosphoric flame retardant is condensed phosphate.

15. The flame-retardant nylon carpet of claim 11, wherein the phosphoric flame retardant is condensed phosphate.

16. The flame-retardant nylon carpet of claim 14, wherein the condensed phosphate is one or two selected from ammonium polyphosphate and melamine polyphosphate.

17. The flame-retardant nylon carpet of claim 15, wherein the condensed phosphate is one or two selected from ammonium polyphosphate and melamine polyphosphate.

18. The flame-retardant nylon carpet of claim 10, wherein the phosphoric flame retardant is a phosphoric ester compound.

19. The flame-retardant nylon carpet of claim 11, wherein the phosphoric flame retardant is a phosphoric ester compound.

20. The flame-retardant nylon carpet of claim 18, wherein the phosphate ester compound is one or two or more selected from the group consisting of 1,3-phenylene bisdiphenyl phosphate, 1,3-phenylene bisdixylenyl phosphate, xylenyl phenyl phosphate and resorcinol bisdiphenyl phosphate.

21. The flame-retardant nylon carpet of claim 19, wherein the phosphate ester compound is one or two or more selected from the group consisting of 1,3-phenylene bisdiphenyl phosphate, 1,3-phenylene bisdixylenyl phosphate, xylenyl phenyl phosphate and resorcinol bisdiphenyl phosphate.

22. A method for manufacturing a flame-retardant nylon carpet comprising a pile yarn containing nylon, a backing fabric containing polyester fiber, and latex used for binding the pile yarn to the backing fabric, the method comprising:
a tufting step of implanting piles of the nylon pile yarn having a limiting oxygen index of 26 or more in the backing fabric containing polyester fiber;
a binding step of coating or impregnating the backing fabric containing polyester fiber with the latex containing 30 to 200 parts by weight of expanded graphite and/or 10 to 100 weight parts by weight of a phosphoric flame retardant with respect to 100 parts by weight of a latex component; and
a curing step of curing the latex with which the backing fabric containing polyester fiber is coated or impregnated.
